(19) United States
(12) Patent Application Publication
(10) Pub. No.: US 2013/0335952 A1
(43) Pub. Date: Dec. 19, 2013

(54) PORTABLE TOILET SOLAR LIGHT SYSTEM

(71) Applicant: Charlene Bull, Winfield, IL (US)

(72) Inventor: Charlene Bull, Winfield, IL (US)

(21) Appl. No.: 13/525,293

(22) Filed: Jun. 16, 2012

(51) Int. Cl. F21L 4/00

(52) U.S. Cl. 362/157

(57) ABSTRACT

The present invention is a portable toilet solar light system utilized by a portable toilet that includes a solar light panel with a plurality of solar cells that receive sunlight and convert the sunlight into electrical energy and a plurality of electrical wires connected to the solar light panel that transmit the electrical energy from the solar light panel. The system also includes a battery that receives and stores the electrical energy transmitted through the electrical wires from the solar light panel and a light disposed in an interior portion of the portable toilet that receives the stored electrical energy from the battery through additional electrical wires.

### TECHNICAL FIELD & BACKGROUND

At many outdoor events such as fairs and concerts, and on construction sites, portable toilets are used to provide restrooms. Some portable toilets are not equipped with lights, making it difficult to see without a flashlight at night or in early dawn.

The present invention generally relates to a solar light system. More specifically, the invention is a portable toilet solar light system.

It is an object of the invention to provide a portable toilet solar light system that provides solar powered light in an interior of a portable toilet.

It is an object of the invention to provide a portable toilet solar light system that provides electrical energy to a battery that can later be utilized to provide electrical power to illuminate an interior of a portable toilet.

It is an object of the invention to provide a portable toilet solar light system that utilizes a relatively efficient light.

What is really needed is a portable toilet solar light system that provides solar powered light in an interior of a portable toilet that provides electrical energy to a battery that can later be utilized to provide electrical power to illuminate an interior of a portable toilet that utilizes a relatively efficient light.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side view of a solar light panel of a portable toilet solar light system, according to an embodiment of the present invention.

FIG. 1B illustrates a front view of a light of a portable toilet solar light system, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

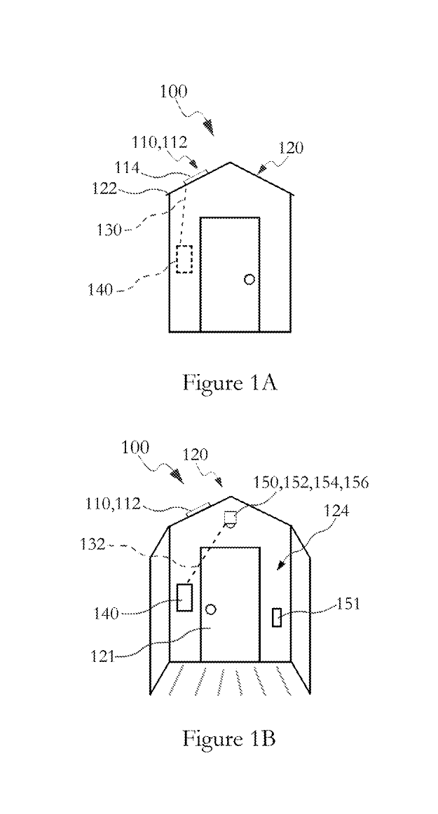

FIG. 1A illustrates a side view of a solar light panel of a portable toilet solar light system 100, according to an embodiment of the present invention. FIG. 1A illustrates a solar light panel 110 of the portable toilet solar light system 100 disposed on a roof 122 of a portable toilet 120. The placement of the solar light panel 110 is well-suited to expose sunlight to the solar light panel 110. The solar light panel 110 is approximately 12 inches in length by 12 inches in width which are well suited dimensions but can be any other suitable dimensions. The solar light panel 110 contains a plurality of solar cells 112 that receive sunlight and convert energy from the sunlight into electrical energy disposed on a top portion 114 of the solar light panel 110.

The portable toilet solar light system 100 also includes a plurality of electrical wires 130 and a battery 140. The electrical wires 130 are connected to the solar light panel 110 and transmit created electrical energy from the solar light panel 110. The battery 140 receives the electrical energy transmitted through the electrical wires 130 that is created from the solar light panel 110. The battery 140 stores the created electrical energy to be accessed and utilized when the solar light panels 110 are not functioning.

FIG. 1B illustrates a front view of a light of a portable toilet solar light system 100, according to an embodiment of the present invention. FIG. 1B illustrates a light 150 that is disposed in an interior portion 124 of the portable toilet 120. The light 150 can receive generated electrical energy directly from the solar light panel 110 through the electrical wires 130 or stored electrical energy from the battery 140 through a plurality of additional electrical wires 132. The light 150 can be an LED light 152, an LCD light 154, a traditional light bulb 156 or other suitable light. The LED light 152 and the LCD light 154 are relatively more efficient than the traditional light bulb 156 and are well-suited for the portable toilet solar light system 100. The light 150 can be activated with an electrical switch 151 or can be activated when a door 121 of the portable toilet 120 is opened.

The portable toilet solar light system is an accessory for portable toilets that provides electricity when a power outlet is not available. The portable toilet solar light system has an approximate 12 inch in length by 12 inch in width solar panel that is attached to the roof of the portable toilet to collect sunlight during the day. To utilize the portable toilet solar light system, simply turn on the light which is connected with a plurality of wires that includes a battery. Individuals who rent portable toilets may find the portable toilet solar light system both convenient and easy to use. The portable toilet solar light system features an attachment for collecting energy from the sun to power a light bulb for indoor use. The portable toilet solar light system is designed to relatively quickly and easily install in a suitable portable toilet.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A portable toilet solar light system utilized by a portable toilet, comprising:
a solar light panel with a top surface, said solar light panel includes a plurality of solar cells disposed on said top surface of said solar light panel, said solar cells receive sunlight and convert energy from said sunlight into electrical energy;
a plurality of electrical wires connected to said solar light panel, said electrical wires transmit said electrical energy from said solar light panel;
a battery that receives and stores said electrical energy transmitted through said electrical wires from said solar light panel wherein said battery is disposed in a discrete housing distinct from said solar light panel; and
a light disposed in an interior portion of said portable toilet, wherein said light is disposed in a discrete housing distinct from said solar light panel and said light receives said stored electrical energy from said battery through additional electrical wires.

2. The portable toilet solar light system according to claim 1, wherein said solar light panel is disposed on a roof of said portable toilet.

3. The portable toilet solar light system according to claim 1, wherein said solar light panel is positioned to expose said sunlight to said solar light panel.

4. The portable toilet solar light system according to claim 1, wherein said light is an LED light.

5. The portable toilet solar light system according to claim 1, wherein the housing in which said battery is disposed is distinct from the housing in which said battery is disposed.

6. The portable toilet solar light system according to claim 1, wherein said light is a traditional light bulb.

7. The portable toilet solar light system according to claim 1, wherein said light is activated with an electrical switch.

8. A portable toilet solar light system utilized by a portable toilet, comprising:
a solar light panel with a top surface, said solar light panel includes a plurality of solar cells disposed on said top surface of said solar light panel, said solar cells receive sunlight and convert energy from said sunlight into electrical energy, wherein said solar light panel is disposed on a roof of said portable toilet;
a plurality of electrical wires connected to said solar light panel, said electrical wires transmit said electrical energy from said solar light panel;
a battery that receives and stores said electrical energy transmitted through said electrical wires from said solar light panel wherein said battery is disposed in a discrete housing distinct from said solar light panel; and
a light disposed in an interior portion of said portable toilet, wherein said light is disposed in a discrete housing distinct from said solar light panel and said light receives said stored electrical energy from said battery through additional electrical wires.

9. The portable toilet solar light system according to claim 8, wherein said solar light panel is positioned to expose said sunlight to said solar light panel.

10. The portable toilet solar light system according to claim 8, wherein said solar light panel is approximately 12 inches in length by 12 inches in width.

11. The portable toilet solar light system according to claim 8, wherein said light is an LED light.

12. The portable toilet solar light system according to claim 8, wherein the housing in which said battery is disposed is distinct from the housing in which said battery is disposed.

13. The portable toilet solar light system according to claim 8, wherein said light is a traditional light bulb.

14. The portable toilet solar light system according to claim 8, wherein said light is activated with an electrical switch.

15. A portable toilet solar light system utilized by a portable toilet, comprising:
a solar light panel with a top surface, said solar light panel includes a plurality of solar cells disposed on said top surface of said solar light panel, said solar cells receive sunlight and convert energy from said sunlight into electrical energy, wherein said solar light panel is disposed on a roof of said portable toilet and is positioned to expose said sunlight to said solar light panel;
a plurality of electrical wires connected to said solar light panel, said electrical wires transmit said electrical energy from said solar light panel;
a battery that receives and stores said electrical energy transmitted through said electrical wires from said solar light panel wherein said battery is disposed in a discrete housing distinct from said solar light panel; and
a light disposed in an interior portion of said portable toilet, wherein said light is disposed in a discrete housing distinct from said solar light panel, said light receives said stored electrical energy from said battery through additional electrical wires, and said light is activated with an electrical switch.

16. The portable toilet solar light system according to claim 15, wherein said solar light panel is approximately 12 inches in length by 12 inches in width.

17. The portable toilet solar light system according to claim 15, wherein said light is an LED light.

18. The portable toilet solar light system according to claim 15, wherein the housing in which said battery is disposed is distinct from the housing in which said battery is disposed.

19. The portable toilet solar light system according to claim 15, wherein said light is a traditional light bulb.

20. The portable toilet solar light system according to claim 15, wherein said light is activated when a door of said portable toilet is opened.
